(19) United States
(12) Patent Application Publication
(10) Pub. No.: US 2025/0238868 A1
(43) Pub. Date: Jul. 24, 2025

(54) SYSTEM AND METHOD FOR GENERATING BUDGETARY RECOMMENDATIONS FOR A USER-SELECTED TARGET ACTIVITY

(71) Applicant: JPMorgan Chase Bank, N.A., New York, NY (US)

(72) Inventors: Abhinandan CHAUDHURY, Bengaluru (IN); Prashanth IYER, Bangalore (IN); Akshay MITTAL, Ghaziabad (IN)

(73) Assignee: JPMorgan Chase Bank, N.A., New York, NY (US)

(21) Appl. No.: 18/594,681

(22) Filed: Mar. 4, 2024

(30) Foreign Application Priority Data
Jan. 18, 2024 (IN) 202411003616

(51) Int. Cl. G06Q 40/06; H04L 67/1396

(52) U.S. Cl. CPC G06Q 40/06; H04L 67/1396

(57) ABSTRACT

A system and method for generating a budgetary recommendation for a user-selected target activity are disclosed. The method includes enabling a user to select a target activity from a plurality of activities. Next, the method includes receiving first information associated with a set of preferences that corresponds to the selected target activity. Next, the method includes retrieving second information associated with the selected target activity and the first information. Next, the method includes analyzing, using a recommendation engine, the first information and the second information to determine a budgetary allocation. Next, the method includes generating a preliminary budgetary recommendation based on the determined budgetary allocation. Next, the method includes rendering, via a display, the preliminary budgetary recommendation to receive a user input. Next, the method includes generating a final budgetary recommendation based on the user input received in response to the preliminary budgetary recommendation.

### CROSS-REFERENCE TO RELATED APPLICATIONS

This application claims priority benefit from Indian Application No. 202411003616, filed on Jan. 18, 2024 in the India Patent Office, which is hereby incorporated by reference in its entirety.

### BACKGROUND

### Field of the Disclosure

This technology generally relates to generating recommendations, and more particularly relates to methods and systems for generating personalized budgetary recommendations for users based on their financial goals.

### Background Information

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Financial planning is an essential activity in today's ever-changing economic landscape. It allows individuals to allocate their resources optimally, ensuring that they can meet their future goals and aspirations. Various tools and methodologies exist in the financial domain to assist individuals in understanding their financial needs and making informed decisions.

Traditional financial planning tools primarily rely on static data inputs and historical trends. While these tools can provide general advice and recommendations, they often lack the ability to adjust dynamically to current socio-economic conditions or unique individual preferences. As a result, individuals may receive generic advice that may not be customized to their specific needs or current economic conditions. Moreover, such tools may not always consider the myriad of activities and goals that an individual might aspire to, such as buying a house, planning for retirement, or going on a vacation.

In one example, as individuals approach retirement and seek to spend quality time with friends and family through travel, they face the challenge of planning and financing their dream vacations. Conventionally, this process involves determining the travel destination, dates, budget, accommodation options, and tourist attractions to visit. While some individuals may navigate this process independently, others seek guidance from travel agents or firms.

For the financial aspect of such travels, individuals may choose to allocate a one-time lump sum or make incremental investments to reach their budgetary goals. Financial institutions offer pre-determined packages for this purpose. However, these packages often lack flexibility and do not consider individual preferences and financial situations, potentially leading to suboptimal or inadequate financial planning.

Hence, in view of these and other existing limitations, there arises an imperative need to provide an efficient solution to overcome the above-mentioned limitations and to provide a method and a system for generating recommendations for a user-selected target activity.

### SUMMARY

The present disclosure, through one or more of its various aspects, embodiments, and/or specific features or sub-components, provides, inter alia, various systems, servers, devices, methods, media, programs, and platforms for generating budgetary recommendations for a user-selected target activity.

According to an aspect of the present disclosure, a method for generating a budgetary recommendation is disclosed. The method is implemented by at least one processor. The method includes enabling, by the at least one processor, a user to select a target activity from a predetermined plurality of activities. The target activity is to be completed within a first predefined time period. Next, the method includes receiving, by the at least one processor, first information associated with a set of preferences that corresponds to the selected target activity. Next, the method includes retrieving, by the at least one processor, second information associated with the selected target activity and the first information. The second information is retrieved from at least one external source. Next, the method includes analyzing, by the at least one processor using a recommendation engine, the first information and the second information to determine a budgetary allocation for the selected target activity. Next, the method includes generating, by the at least one processor, a preliminary budgetary recommendation based on the determined budgetary allocation. Next, the method includes rendering, by the at least one processor via a display, the preliminary budgetary recommendation to receive a user input. Next, the method includes generating, by the at least one processor, a final budgetary recommendation based on the user input received in response to the preliminary budgetary recommendation.

In accordance with an exemplary embodiment, the method further includes analyzing, by the at least one processor, the user input to identify a user behavioral pattern towards the rendered preliminary budgetary recommendation. Next, the method includes predicting, by the at least one processor using the recommendation engine, an optimal amount for the final budgetary recommendation based on a result of the analyzing of the user behavioral pattern.

In accordance with an exemplary embodiment, the predetermined plurality of activities includes retirement planning, house purchase planning, vacation planning, vehicle purchase planning, wedding planning, education planning, and at least one other type of financial planning.

In accordance with an exemplary embodiment, the first information includes at least one from among a time horizon, a destination preference, a transportation preference, a dining preference, a shopping preference, an accommodation preference, an itinerary preference and any other target activity related preference, wherein the second information includes economic indicator data that includes at least one from among price trends, inflation trends, current news, current affairs, market trends, purchasing power parity trends, foreign exchange rate trends, and any other economic indicators associated with the selected target activity.

In accordance with an exemplary embodiment, the method further includes periodically determining, by the at least one processor, a change in the second information upon completion of a second predefined time period. Next, the method includes optimizing, by the at least one processor, the final budgetary recommendation to enable completion of the selected target activity within the first predefined time period based on the change in the second information. The first predefined time period is one from among a user-defined time period and a time period that is defined by the recommendation engine. Next, the method includes transmitting, by the at least one processor, a notification to alert the user about the optimized final budgetary recommendation.

In accordance with an exemplary embodiment, the method further includes recommending, by the at least one processor, at least one mini-pot to achieve a budgetary amount, corresponding to the final budgetary recommendation, within the first predefined time period.

In accordance with an exemplary embodiment, the method further includes receiving, by the at least one processor, a modification input from the user to perform at least one from among an addition, a deletion, and a modification in the recommended at least one mini-pot.

In accordance with an exemplary embodiment, the method further includes one from among automatically recommending, by the at least one processor, an allocation of at least one asset for the recommended at least one mini-pot and receiving, by the at least one processor, the user input to manually allocate the at least one asset to each of the recommended at least one mini-pot.

In accordance with an exemplary embodiment, the method further includes determining, by the at least one processor, a confidence score corresponding to the allocated at least one asset, wherein the confidence score represents a probability of the allocation of the at least one asset to achieve the selected target activity within the first predefined time period.

According to another aspect of the present disclosure, a computing device configured to implement an execution of a method for generating a budgetary recommendation is disclosed. The computing device includes a processor; a memory; and a communication interface coupled to each of the processor and the memory. The processor may be configured to enable a user to select a target activity from a predetermined plurality of activities. The target activity is to be completed within a first predefined time period. Next, the processor may be configured to receive first information associated with a set of preferences that corresponds to the selected target activity. Next, the processor may be configured to retrieve second information associated with the selected target activity and the first information. The second information is retrieved from at least one external source. Next, the processor may be configured to analyze, using a recommendation engine, the first information and the second information to determine a budgetary allocation for the selected target activity. Next, the processor may be configured to generate a preliminary budgetary recommendation based on the determined budgetary allocation. Next, the processor may be configured to render, via a display, the preliminary budgetary recommendation to receive a user input. Next, the processor may be configured to generate a final budgetary recommendation based on the user input received in response to the preliminary budgetary recommendation.

In accordance with an exemplary embodiment, the processor may be configured to analyze the user input to identify a user behavioral pattern towards the rendered preliminary budgetary recommendation. Next, the processor may be configured to predict, using the recommendation engine, an optimal amount for the final budgetary recommendation based on the analysis of the user behavioral pattern.

In accordance with an exemplary embodiment, the plurality of activities includes retirement planning, house purchase planning, vacation planning, vehicle purchase planning, wedding planning, education planning, and at least one other type of financial planning.

In accordance with an exemplary embodiment, the first information includes at least one from among a time horizon, a destination preference, a transportation preference, a dining preference, a shopping preference, an accommodation preference, an itinerary preference and any other target activity related preference, wherein the second information includes economic indicator data that includes at least one from among price trends, inflation trends, current news, current affairs, market trends, purchasing power parity trends, foreign exchange rate trends, and any other economic indicators associated with the target activity.

In accordance with an exemplary embodiment, the processor may be further configured to periodically determine a change in the second information upon completion of second predefined time period. Next, the processor may be configured to optimize the final budgetary recommendation to enable completion of the selected target activity within the first predefined time period based on the change determined in the second information. The first predefined time period is one from among a user-defined time period and a time period that is defined by the recommendation engine. Next, the processor may be configured to transmit a notification to alert the user about the optimized final budgetary recommendation.

In accordance with an exemplary embodiment, the processor may be further configured to recommend at least one mini-pot to achieve a budgetary amount, corresponding to the final budgetary recommendation, within the first predefined time period.

In accordance with an exemplary embodiment, the processor may be further configured to receive a modification input from the user to perform at least one from among an addition, a deletion, and a modification in the recommended at least one mini-pot.

In accordance with an exemplary embodiment, the processor may be further configured to perform one from among automatically recommending an allocation of at least one asset for the recommended at least one mini-pot and receiving the user input to manually allocate the at least one asset to each of the recommended at least one mini-pot.

In accordance with an exemplary embodiment, the processor may be further configured to determine a confidence score corresponding to the allocated asset. The confidence score represents a probability of the allocation of the at least one asset to achieve the selected target activity within the first predefined time period.

According to yet another aspect of the present disclosure, a non-transitory computer-readable storage medium storing instructions for generating a budgetary recommendation is disclosed. The instructions include executable code which, when executed by a processor, may cause the processor to enable a user to select a target activity from a predetermined plurality of activities, wherein the target activity is to be completed within a first predefined time period; receive first information associated with a set of preferences that corresponds to the selected target activity; retrieve a second information associated with the selected target activity and the first information, wherein the second information is retrieved from at least one external source; analyze, using a recommendation engine, the first information and the second information to determine a budgetary allocation for the selected target activity; generate a preliminary budgetary recommendation based on the determined budgetary allocation; render, via a display, the preliminary budgetary recommendation to receive a user input; and generate a final budgetary recommendation based on the user input received in response to the preliminary budgetary recommendation.

In accordance with an exemplary embodiment, the executable code when executed causes the processor to analyze the user input to identify a user behavioral pattern towards the rendered preliminary budgetary recommendation. Next, the executable code when executed causes the processor to predict, using the recommendation engine, an optimal amount for the final budgetary recommendation based on the analysis of the user behavioral pattern.

In accordance with an exemplary embodiment, the plurality of activities includes retirement planning, house purchase planning, vacation planning, vehicle purchase planning, wedding planning, education planning, and at least one other type of financial planning.

In accordance with an exemplary embodiment, the first information includes at least one from among a time horizon, a destination preference, a transportation preference, a dining preference, a shopping preference, an accommodation preference, an itinerary preference and any other target activity related preference, wherein the second information includes economic indicator data that comprises at least one from among price trends, inflation trends, current news, current affairs, market trends, purchasing power parity trends, foreign exchange rate trends, and any other economic indicators associated with the target activity.

In accordance with an exemplary embodiment, the executable code when executed causes the processor to periodically determine a change in the second information upon completion of a second predefined time period. Next, the executable code when executed causes the processor to optimize the final budgetary recommendation to enable completion of the selected target activity within the first predefined time period based on the change determined in the second information. The first predefined time period is one from among a user-defined time period and a time period that is defined by the recommendation engine. Next, the executable code when executed causes the processor to transmit a notification to alert the user about the optimized final budgetary recommendation.

In accordance with an exemplary embodiment, the executable code when executed causes the processor to recommend at least one mini-pot to achieve a budgetary amount, corresponding to the final budgetary recommendation, within the first predefined time period.

In accordance with an exemplary embodiment, the executable code when executed causes the processor to receive a modification input from the user to perform at least one from among an addition, a deletion, and a modification in the recommended at least one mini-pot.

In accordance with an exemplary embodiment, the executable code when executed causes the processor to perform one from among automatically recommending an allocation of at least one asset for the recommended at least one mini-pot and receiving the user input to manually allocate the at least one asset to each of the recommended at least one mini-pot.

In accordance with an exemplary embodiment, the executable code when executed causes the processor to determine a confidence score corresponding to the allocated asset. The confidence score represents a probability of the allocation of the at least one asset to achieve the selected target activity within the first predefined time period.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for generating budgetary recommendations, in accordance with an exemplary embodiment of the present disclosure.

FIG. 2 illustrates an exemplary diagram of a network environment for generating budgetary recommendations, in accordance with an exemplary embodiment of the present disclosure.

FIG. 3 illustrates an exemplary system for generating budgetary recommendations, in accordance with an exemplary embodiment of the present disclosure.

FIG. 4 illustrates an exemplary method flow diagram for generating budgetary recommendations, in accordance with an exemplary embodiment of the present disclosure.

FIG. 5 illustrates a process flow diagram usable for generating budgetary recommendations, in accordance with an exemplary embodiment of the present disclosure.

FIG. 6 illustrates an exemplary system flow diagram of a recommendation engine for generating recommendations, in accordance with an embodiment of the present disclosure.

FIG. 7 illustrates an exemplary system flow diagram for ranking asset recommendations based on confidence score, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for generating a budgetary recommendation. For example, system facilitates in providing the budgetary recommendation to a user based on user preferences and socio-economic trends. Initially, the system receives first information associated with a set of preferences of the user that corresponds to a target activity. The user may manually enter or select the set of preferences in a user interface (UI) rendered on a display unit of a user device. The selected set of preferences of the user may be stored as the first information in a database. The target activity may correspond to a financial goal that the user wants to achieve within a first predefined time period. In some examples, the first predefined time period may include one month, one year, four years, and the like.

Next, the system retrieves second information associated with the target activity and the first information. For example, if the target activity is house purchase planning, then the second information may include inflation trends in the country/city where the user is planning to purchase the house. The second information may be retrieved from an external source (e.g., government databases, financial databases, etc.).

The system further utilizes a recommendation engine to analyze the first information and the second information to determine a budgetary allocation for the selected target activity to be completed within the first predefined time period. In one exemplary implementation, the recommendation engine may implement or run a trained model. In some examples, the trained model may include machine learning algorithm, artificial intelligence algorithm, neural network model (e.g., convolution neural network (CNN), recurrent neural network (RNN), etc.), and the like.

The system further generates a preliminary budgetary recommendation based on the determined budgetary allocation. The preliminary budgetary recommendation is generated based on the selected target activity. The preliminary budgetary recommendation is then rendered on the display unit (also referred to herein as “the display”) of the user device for user input such as user review and approval. The user has an option to make changes in the preliminary budgetary recommendation as per requirement.

Once the user provides the approval on the preliminary budgetary recommendation, the system generates a final budgetary recommendation. The investments may further be made based on the final budgetary recommendation.

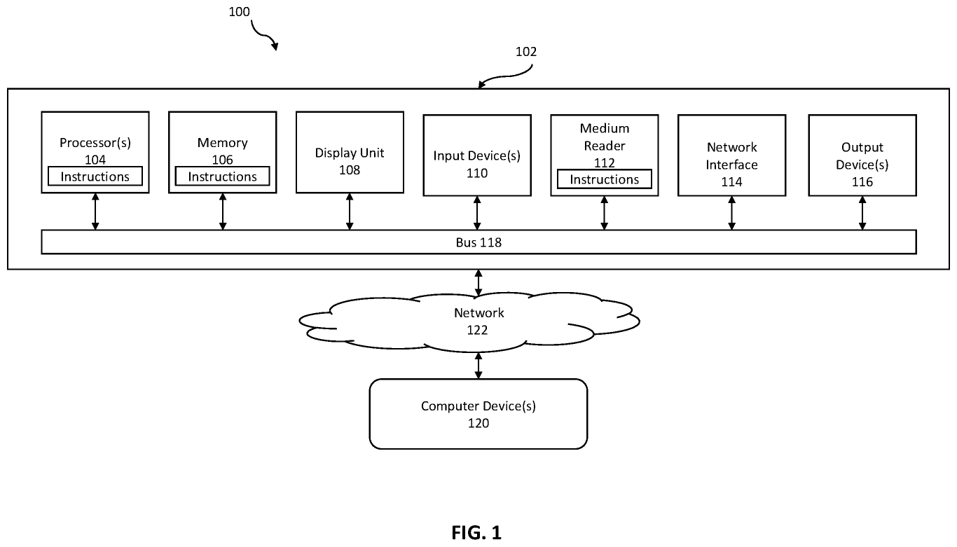

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for generating budgetary recommendations.

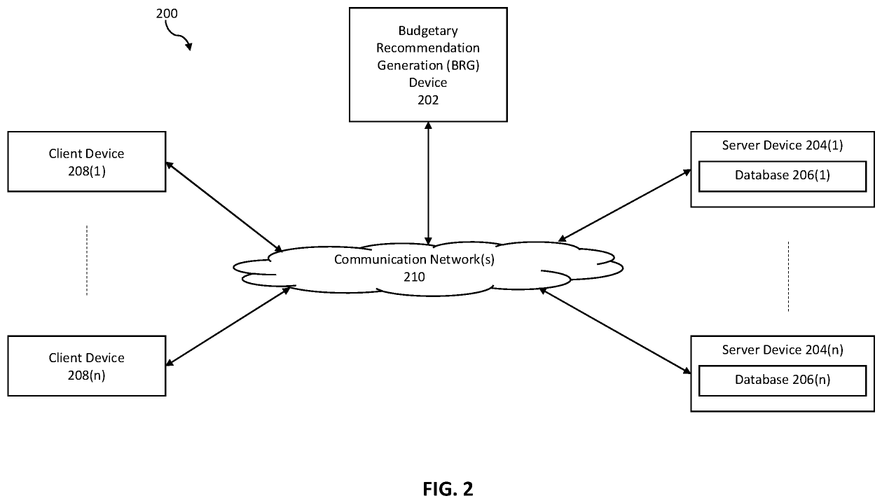

Referring to FIG. 2, a schematic of an exemplary network environment 200 for implementing a method for generating a budgetary recommendation is illustrated. In an exemplary embodiment, the method is executable on any networked computer platform, such as, for example, a personal computer (PC).

The method for generating budgetary recommendations may be implemented by a budgetary recommendation generation (BRG) device 202. The BRG device 202 may be the same or similar to the computer system 102 as described with respect to FIG. 1. The BRG device 202 may store one or more applications that can include executable instructions that, when executed by the BRG device 202, cause the BRG device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the BRG device 202 itself, may be located in the virtual server(s) running in a cloud-based computing environment rather than being tied to one or more specific physical network computing devices. Also, the application(s) may be running in one or more virtual machines (VMs) executing on the BRG device 202. Additionally, in one or more embodiments of this technology, virtual machine(s) running on the BRG device 202 may be managed or supervised by a hypervisor.

In the network environment 200 of FIG. 2, the BRG device 202 is coupled to a plurality of server devices 204(1)-204(n) that hosts a plurality of databases 206(1)-206(n), and also to a plurality of client devices 208(1)-208(n) via communication network(s) 210. A communication interface of the BRG device 202, such as the network interface 114 of the computer system 102 of FIG. 1, operatively couples and communicates between the BRG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the BRG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and BRG devices that efficiently implement the method for generating budgetary recommendations.

By way of example only, the communication network(s) 210 may include local area network(s) (LAN(s)) or wide area network(s) (WAN(s)), and can use TCP/IP over ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The BRG device 202 may be a standalone device or integrated with one or more other devices or apparatuses, such as one or more of the server devices 204(1)-204(n), for example. In one particular example, the BRG device 202 may include or be hosted by one of the server devices 204(1)-204(n), and other arrangements are also possible. Moreover, one or more of the devices of the BRG device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the BRG device 202 via the communication network(s) 210 according to the hypertext transfer protocol (HTTP)-based and/or java script object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a preliminary budgetary recommendation, a final budgetary recommendation, and recommendations provided by the machine learning models and the training data for the machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the BRG device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the BRG device 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the BRG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the BRG device 202, the server devices 204(1)-204(n), or the client devices 208(1)-208(n), for example, may be configured to operate as virtual instances on the same physical machine. In other words, one or more of the BRG device 202, the server devices 204(1)-204(n), or the client devices 208(1)-208(n) may operate on the same physical device rather than as separate devices communicating through communication network(s) 210. Additionally, there may be more or fewer BRG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the internet, intranets, and combinations thereof.

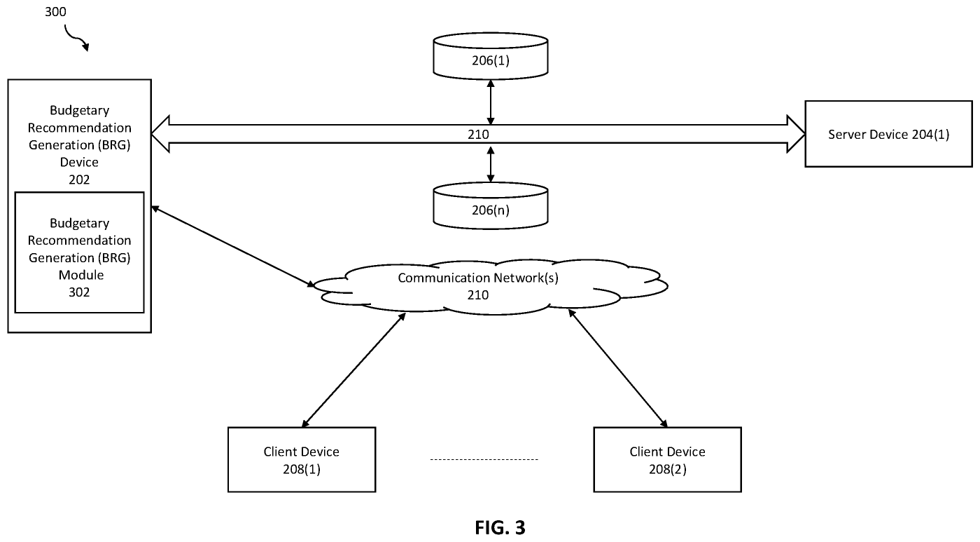

FIG. 3 illustrates an exemplary system for implementing a method for generating budgetary recommendations, in accordance with an exemplary embodiment. As illustrated in FIG. 3, according to exemplary embodiments, the system 300 may comprise a BRG device 202 including a budgetary recommendation generation (BRG) module 302 that may be connected to a server device 204(1) and one or more repository from the repositories 206(1) . . . 206(n) via a communication network 210, but the disclosure is not limited thereto.

The BRG device 202 is described and shown in FIG. 3 as including the BRG module 302, although it may include other rules, policies, modules, databases, or applications, for example. As will be described below, the BRG module 302 is configured to implement a method for generating budgetary recommendations.

An exemplary system 300 for implementing a mechanism for generating budgetary recommendations by utilizing the network environment of FIG. 2 is shown as being executed in FIG. 3. Specifically, a first client device 208(1) and a second client device 208(2) are illustrated as being in communication with BRG device 202. In this regard, the first client device 208(1) and the second client device 208(2) may be “clients” of the BRG device 202 and are described herein as such. Nevertheless, it is to be known and understood that the first client device 208(1) and/or the second client device 208(2) need not necessarily be “clients” of the BRG device 202, or any entity described in association therewith herein. Any additional or alternative relationship may exist between either or both of the first client device 208(1) and the second client device 208(2) and the BRG device 202, or no relationship may exist.

Further, the BRG device 202 is illustrated as being able to access one or more repositories 206(1) . . . 206(n). The BRG module 302 may be configured to access these repositories/databases for implementing a method for generating budgetary recommendations.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the BRG device 202 via broadband or cellular communication. These embodiments are merely exemplary and are not limiting or exhaustive.

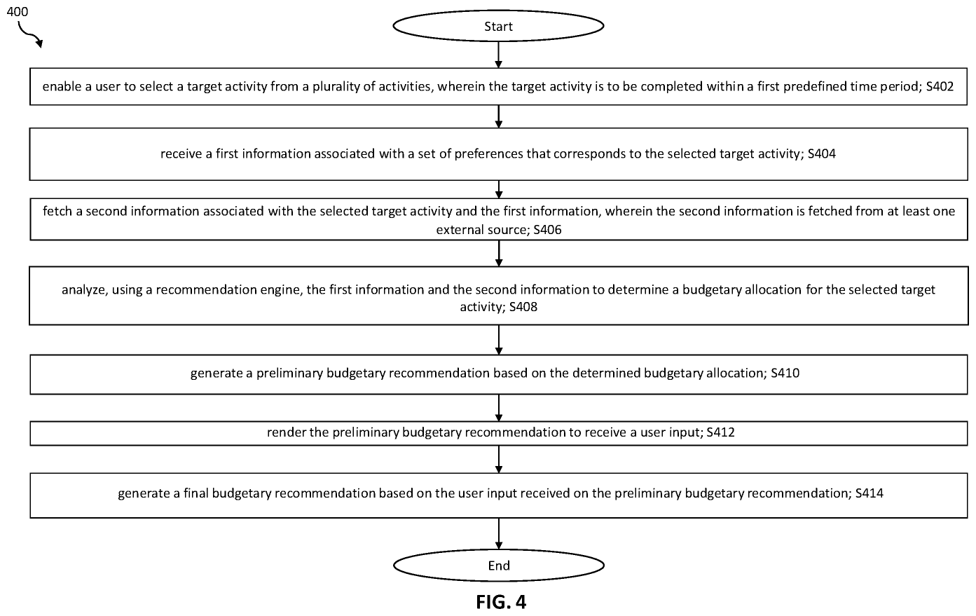

Referring to FIG. 4, an exemplary method 400 is shown for generating budgetary recommendations, in accordance with an exemplary embodiment. In particular, the exemplary method 400 is shown for generating a budgetary recommendation. In an example, the budgetary recommendation may be generated for a user-selected target activity.

The method 400 is shown for generating customized budgetary recommendations for a user. For example, the budgetary recommendations generated for a user X will always be different from the budgetary recommendations generated for a user Y. The method 400 is shown for generating the budgetary recommendations based on user preferences selected by the user.

As shown in FIG. 4, the method 400 begins following a need for generating budgetary recommendations for the user. The user may wish to generate the budgetary recommendation for a target activity. The method 400 is implemented by at least one processor 104.

At step S402, the method 400 comprises enabling, by the at least one processor 104, the user to select a target activity from a predetermined plurality of activities. The selected target activity is to be completed within a first predefined time period. The term “target activity” herein may correspond to a financial goal that the user wishes to achieve or fulfill within the first predefined time period (such as day(s), month(s) or year(s)).

The first predefined time period is one from among a user-defined time period and a time period that is defined by a recommendation engine. In an implementation, the recommendation engine may recommend the first predefined time period. In another implementation, the user may select or enter the first predefined time period using an input device (e.g., keyboard, mouse, etc.) on a user interface (UI) rendered on a user device of the user.

In some examples, the user device may include one of a tablet, a smartphone, a laptop, a desktop computer, a mainframe computer, a phablet, a smart watch, a personal digital assistant (PDA), and the like.

For example, a user interface (UI) may be rendered on a display unit of the user device. The user can also use the input device to enter or select the target activity on the UI rendered on the display unit. The predetermined plurality of activities may comprise retirement planning, house purchase planning, vacation planning, vehicle purchase planning, wedding planning, education planning, and/or other types of financial planning. For example, the user wants to plan a vacation to Europe from India.

For the sake of simplicity, let us consider that the user may select the target activity as “vacation planning” from the plurality of activities.

At step S404, the method includes receiving, by the at least one processor 104, first information associated with a set of preferences that corresponds to the selected target activity. The first information comprises at least one from among a time horizon, a destination preference, a transportation preference, a dining preference, a shopping preference, an accommodation preference, an itinerary preference, and any other target activity related preference. In an implementation, the first information is received from the user device of the user.

The user may enter or select the set of preferences using the input device. The user may enter or select the set of preferences on a UI rendered on the display unit of the user device. In some examples, the first information may include a destination of a vacation, a time horizon for a vacation (e.g., tentative date such as 23 Sep. 2035, year range such as 2035-2036, specific year such as 2040, etc.), a tentative itinerary of list of tourist attractions that the user wishes to visit, and/or other preferences (e.g., transportation preferences, shopping preferences, etc.).

The method employed to receive the first information can include direct user input through an interactive user interface (UI) where the user fills out forms or answers questions. In another exemplary implementation, the method for receiving the first information can include importing data from external financial management software or platforms the user might be using. In yet another implementation, the method for receiving the first information can include scanning and processing physical or electronic documents provided by the user, such as bank statements, etc. Upon receipt of the first information, the at least one processor 104 may initially parse and classify the data for easier processing in subsequent steps.

In one example, the recommendation engine may recommend various available itineraries to the user. The user may then select the preferred itinerary from the available itineraries.

For example, the transportation preference may include one from among air transport, ferry, trucks, taxi/cab, rail transport, bus, tram, mass rapid transit, maritime transport (ferry), and other multi-modal transport options. For example, the dining preference may include one from among fine dining, fast casual, family style, food truck/cart/stand, buffet style, coffee house, contemporary casual, destination restaurant, casual dining, ghost restaurant (delivery only), fast food, café, pub, diner, bistro, brasserie, and the like.

For example, the shopping preference may include one from among department store, discount store, hypermarket, chain store, gift shop, supermarket, convenience store, big-box store, grocery store, specialty store, and the like.

For example, the accommodation preference may include one from among apartment type (e.g., studio apartment, x-bedroom apartment, apartment hotel, etc.), bed and breakfast options, boutique hotel, bungalow/single family homes, capsule hotel, chalet, cottage, farm stay, glamping, guest house, hotel rating (e.g., 3-star, 4-star, 5-star, 7-star, etc.), homestay, holiday home, inn, log cabin, motel, resort, vacation rental, villa, and the like.

At step S406, the method comprises fetching (or retrieving), by the at least one processor 104, second information associated with the selected target activity and the first information. The second information is fetched from at least one external source.

The second information includes economic indicator data that includes at least one from among price trends, inflation trends, current news, current affairs, market trends, purchasing power parity trends, foreign exchange rate trends, and any other economic indicators associated with the selected target activity.

To complement the macroeconomic indicators, financial metrics such as inflation rate trends, consumer confidence index, consumer price index, and purchasing power parity are considered for the country and city associated with the target activity. This may provide a nuanced understanding of consumer behavioral and price stability, which could affect the value and utility of the funds in question.

It would be appreciated by the person skilled in the art that the second information facilitates in incorporating the broader economic and social landscapes. This aids the recommendation engine in making a more informed and optimized asset allocation recommendation while drafting a budgetary recommendation that is reflective of current realities and future projections and is not based on bias of an individual user.

For example, the economic indicator data may include one from among an inflation rate for the selected travel destination, inflation rate trends for the selected travel destination, a consumer price index for the selected travel destination, a consumer price inflation index for the selected travel destination, purchasing power parity trends for the selected travel destination, airfare trends for the selected travel destination, market trends for various investment options, current news regarding any social or political turmoil in and around the selected travel destination, current news regarding any widespread health illness or pandemic affecting the selected travel destination, news and other current affairs relating to the geo-political realities in and around the chosen travel destination, and the like.

The at least one processor 104 is configured to fetch the second information from the at least one external source. The at least one external source may include any one or more of databases, financial institutions, economic research organizations, government agencies, news outlets, and the like.

The second information may be fetched using a secure data communication protocol to ensure the integrity and confidentiality of the second information. Once the processor 104 successfully fetches the second information, the processor 104 integrates the second information with the first information to enhance the ability of the method 400 to generate a more optimized and context-aware preliminary and final budgetary recommendation. It will be appreciated by the person skilled in the art that the aim here is to create a more dynamic and responsive budgetary recommendation generation system. By considering both micro-level data like individual preferences and macro-level data like economic indicators, the system can adapt to a wide variety of conditions and offer budgetary recommendation recommendations that are both personalized and robustly informed.

At step S408, the method comprises analyzing, by the at least one processor 104 using a recommendation engine, the first information and the second information to determine a budgetary allocation for the selected target activity to be completed within the first predefined time period. In particular, the budgetary allocation is determined based on the selected target activity.

In one implementation, the recommendation engine may implement a hardware-run model to perform the analyzing step. In an implementation, the hardware-run model is a machine learning (ML) model. In another exemplary implementation, the hardware-run model is an artificial intelligence (AI) model. In yet another exemplary implementation, the hardware-run model is a deep learning (DL) model. In yet another exemplary implementation, the hardware-run model is a neural network (NN) model. In some examples, the NN model may include a convolutional neural network (CNN) model, a recurrent neural network (RNN) model, and the like.

The budgetary allocation herein may correspond to an asset value (e.g., financial amount) that the user needs to save in order to achieve the target activity in the first predefined time period. The asset value may be calculated based on the analysis of the first information and the second information.

The recommendation engine employed by the processor 104 in step S408 may use various algorithms to analyze the first information and the second information in tandem. It will be appreciated by the person skilled in the art that the goal herein is to generate a budgetary recommendation that not only meets the user's preferences but is also resilient to economic fluctuations and other external factors or trends.

Moreover, the recommendation engine could use machine learning techniques to predict future asset requirement or depreciation based on historical and real-time data, thereby aiding in long-term planning. The analysis might reveal, for example, that allocating a higher percentage of liquid assets like stocks to long-term goals may be beneficial due to the long-term growth potential, whereas allocating stable but less liquid assets like fixed deposits to a short-term goal may offer immediate financial security. After the analysis, the budgetary allocation may be derived, which may then be used to generate the preliminary budgetary recommendation draft in the subsequent steps.

The recommendation engine may utilize both the first information related to the user's preferences, and the second information comprising external economic and social indicators to create a comprehensive dataset for analysis. The recommendation engine analyzes various economic indicators like inflation rates, interest rates, and the like, along with user-selected preferences. Using machine learning, the recommendation engine is capable of projecting future asset values, allowing for long-term planning. Thus, the recommendation engine can adapt recommendations based on historical data and predictive analytics, considering factors like market trends and economic forecasts. The recommendation engine may optimize allocation of assets in a way that meets the user's preferences while also considering the long-term economic security. For instance, it might allocate riskier but potentially higher-reward assets to long-term goals and more stable assets to short-term goals. The recommendation engine can update itself based on the user input received on the preliminary budgetary recommendation. This ensures that the model becomes more accurate over time and can optimize recommendations according to the user's needs. The recommendation engine may be configured such that to consider legal frameworks relevant to the target activity, ensuring that the budgetary recommendation is not just optimized but also legally compliant. In an advanced setup, the recommendation engine could also periodically review and recommend adjustments to the budgetary recommendation based on new data, keeping the budgetary recommendation up-to-date with the latest economic and personal situations.

At step S410, the method comprises generating, by the at least one processor 104, a preliminary budgetary recommendation based on the determined budgetary allocation. The preliminary budgetary recommendation is generated based on the selected target activity.

The UI is specifically designed to convert the document format of the preliminary budgetary recommendation into a visually accessible and easily navigable layout. Various features like zoom-in/zoom-out, scroll, and section highlights might be provided to improve the user's engagement with the document. Additionally, tooltips or guidance notes could be embedded to explain technical jargon or specific allocations, further enhancing user comprehension.

At step S412, the method comprises rendering, by the at least one processor 104 via a display unit, the preliminary budgetary recommendation to receive a user input. The preliminary budgetary recommendation is rendered on the display unit of the user device. Further, the method comprises receiving, by the at least one processor 104, the user input based on the rendered preliminary budgetary recommendation.

For example, the preliminary budgetary recommendation is rendered on the display unit of the user device. The preliminary budgetary recommendation includes the determined budgetary allocation (e.g., financial amount) and the parameters used to calculate the budgetary allocation. The determined budgetary allocation (e.g., financial amount) and the parameters are rendered on the display unit for user review and approval.

It would be appreciated by the person skilled in the art that the preliminary budgetary recommendation serves not just as a static document but as an interactive tool that engages the user in a feedback loop. This creates a more dynamic, adaptable, and intelligent system for asset allocation and planning, capable of evolving based on user input and experience.

For example, if the preliminary budgetary recommendation has allocated an equity fund to mini-pot A, a debt fund to mini-pot B, and a gold fund to mini-pot C, each section of the preliminary budgetary recommendation rendered on the display unit may include an interactive icon. When the user hovers over or clicks on these icons, a tooltip might appear, providing more context or rationale behind each asset allocation. Further, the UI could also incorporate interactive features that allow the user to make quick edits or to flag sections for later review. These interactive capabilities serve as the foundation for potential refinement of the preliminary budgetary recommendation, as the user could immediately respond with their input or comments.

In one implementation, the user has an option to override the determined budgetary allocation and also provide comments for such change. The comments may be used as feedback by the recommendation engine.

Upon receiving the user input, the method comprises analyzing, by the at least one processor 104, the user input to identify a user behavioral pattern towards the rendered preliminary budgetary recommendation. Further, method may comprise predicting, by the at least one processor 104 using the recommendation engine, an optimal amount for the final budgetary recommendation based on the analysis of the user behavioral pattern. The behavioral pattern may correspond to spending habits of the user.

The term “optimal amount” herein may represent a round-off amount that the user can save in each electronic transaction (e.g., financial transaction) in order to accumulate the determined budgetary allocation. The round-off amount may refer to a small, typically insignificant, difference between an exact transaction value and a value that has been rounded to a specific number of figures. For example, the user has to purchase a hamburger worth $7. Instead of making the electronic transaction for $7, the user performs the electronic transaction worth $10. The balance amount, e.g., $3, is considered as the round-off amount (e.g., the optimal amount).

In an implementation, the optimal amount may be predicted based on a time period. For example, the recommendation engine may determine the number of electronic transactions that the user performs in a day from the financial statements of the user. The recommendation engine may further predict the number of electronic transactions that the user is expected to perform each day. Based on the determination, the recommendation engine may predict an optimal amount that must be saved each day to achieve the target activity in the first predefined time period.

In this manner, the optimal amount can be calculated for various time periods such as daily, weekly, monthly, quarterly, yearly, and the like. The user has an option to override the optimal amount as per requirement. The user may use the input device to override the optimal amount and also provide the comments for overriding the optimal amount.

The feature to override ensures that the recommendation engine becomes increasingly accurate and tailored to the user's specific needs and preferences over time. For example, if a user consistently overrides the trained model's recommendations in favor of a higher allocation to the optimal amount, the trained model will learn from this behavior. Subsequent recommendations will then be more aligned with the user's actual preferences, leading to an increasingly personalized experience.

Additionally, the override feature allows the trained model to adapt to changes in user behavior or circumstances that may not be immediately captured by economic indicators or market data. Further, the updating of the recommendation engine adds a layer of adaptability to the system. By continually learning from the user input, the recommendation engine ensures that the recommendations are relevant and timely, thereby enhancing the utility and effectiveness of the overall system.

It will be appreciated by the person skilled in the art that the ability to update the recommendation engine based on user input not only improves the accuracy of budgetary recommendation generation but also enhances the system's adaptability and personalization capabilities override positions the system as a dynamic, long-term solution for asset management and planning, capable of evolving with both market conditions and individual user needs.

In case the user does not provide consent, the recommendation engine suggests the optimal amount based on the budgetary allocation recommendations and the like.

The method further comprises recommending, by the at least one processor 104, at least one mini-pot to achieve a budgetary amount, corresponding to a final budgetary recommendation within the first time period. The term “mini-pots” herein may represent smaller compartments or categories within the overall budget (e.g., final budgetary recommendation).

In an exemplary implementation, the recommendation engine is configured to recommend the at least one mini-pot based on the analysis of the first information and the second information. In another exemplary implementation, the recommendation engine is configured to recommend the at least one mini-pot based on the analysis of the financial statements of the user. In yet another exemplary implementation, the recommendation engine is configured to recommend the at least one mini-pot based on the analysis of the first information, the second information, and the financial statements of the user.

In one implementation, each mini-pot corresponds to a sub-category of the selected target activity. For example, if the target activity is travel, the at least one mini-pot can include a transportation mini-pot, an accommodation mini-pot, and/or other similar types of mini-pots.

In one example, the recommendation engine may recommend the user on how to distribute funds among the at least one mini-pot and savings. This distribution is determined based on the analysis of the spending habits of the user and user-selected preferences in the first information (e.g., dining, accommodation, transportation, and shopping).

Moreover, the method comprises receiving, by the at least one processor 104, a modification input from the user to perform a modification operation on the at least one mini-pot. The modification operation includes one from among an addition, a deletion, and/or a modification in the recommended at least one mini-pot.

For example, the user has an option to manually remove any of the suggested mini-pot, combine at least two mini-pots, or add additional mini-pots based on their preference. The user then needs to confirm at least one mini-pot (such as a list of mini-pots) as a final confirmation of their selection. The at least one mini-pot (such as list of mini-pots) selected by the user in the preliminary budgetary recommendation may be represented as a user-selected mini-pot.

The method further comprises recommending, by the at least one processor 104, at least one asset pertaining to each user-selected mini-pot. For example, the at least one asset may include any one or more of a savings account, recurring deposits, bonds, equities, exchange traded funds (ETFs), stocks, gold funds, fixed deposits, self-managed equities, self-managed debt funds, balanced advantage funds, aggressive funds, mutual funds, government securities, bonds, and the like.

The method also comprises determining, by the at least one processor 104, a confidence score corresponding to the at least one asset. The confidence score may represent the probability of the allocation of the at least one asset to achieve the selected target activity within the first predefined time period.

In one implementation, the recommendation engine automatically recommends the at least one asset for each mini-pot depending on the volatility of the category of the mini-pot. For example, accommodation options are not as volatile as air travel. Thus, the recommendation engine recommends a debt fund as an investment option for an accommodation mini-pot, whereas the travel mini-pot receives equity investment as a suggested investment.

In one implementation, the user input is received to manually allocate the at least one asset to each of the recommended at least one mini-pot.

Further, the investment suggestions (e.g., the at least one asset) provided by the recommendation engine are ranked based on the confidence scores, allowing the user to easily see the most relevant options from the at least one asset recommendation shown in the preliminary budgetary recommendation.

The user is required to provide a consent (e.g., user approval) for the selected asset. In case the user does not provide the user approval for an asset (e.g., the user may forget to provide the consent or select the recommended asset), the recommendation engine may remove the corresponding mini-pot from the at least one mini-pot (such as list of selected mini-pots).

At step S414, the method comprises generating, by the at least one processor 104, a final budgetary recommendation based on the user approval on the preliminary budgetary recommendation. For example, the user provides the approval on the at least one mini-pot (such as user selected mini-pots) and the selected asset recommendation for each mini-pot. Upon receiving the user approval, the recommendation engine generates the final budgetary recommendation for the user review and approval.

In one implementation, the selected asset recommendation, along with the distribution of funds to each mini-pot are displayed on the UI on the display unit, for final confirmation. Upon receiving the user approval, the method 400 further comprises registering, by the at least one processor 104, a standing instruction (SI) to transfer the optimal amount in a financial account of the user.

For example, once confirmed (e.g., user approval), the user has an option to setup the standing instruction (SI) to invest the optimal amount to the financial account, once the optimal amount reaches a threshold. The SI may be set up to trigger when the optimal amount reaches a certain threshold. The threshold may be a predefined level, and the investment action is only taken when the optimal amount reaches or exceeds the threshold limit. In an exemplary implementation, the recommendation engine recommends the threshold. In another exemplary implementation, the user sets the threshold.

Upon acceptance of the final budgetary recommendation, the funds of the user are set up to be invested in the user-selected at least one asset in each user-selected mini-pot. In an exemplary implementation, the user may set up the SI to automatically invest the funds in the user-selected at least one asset in each user selected mini-pot. In another exemplary implementation, the user may manually invest the funds in the user-selected at least one asset in each user selected mini-pot as per convenience.

In addition, the method comprises periodically determining, by the at least one processor 104, a change in the second information after a second predefined time period. For example, the second predefined time period may include daily, weekly, monthly, and the like. Further, the method comprises optimizing, by the at least one processor 104, the budgetary allocation recommendation to enable completion of the target activity within the first predefined time period based on the determined periodic change. Furthermore, the method comprises transmitting, by the at least one processor 104 via a display unit, a notification to the user device of the user to alert the user about the optimized budgetary allocation recommendation.

The notification can be customized to be delivered via various channels, such as email, short message service (SMS), or even as a push notification from an application, depending on the system's capabilities and the user's preferences. Thus, the method's ongoing review and update features offer a dynamic, responsive system that adapts to changing conditions while also allowing the user to modify and thus control their own recommendation and asset recommendation. This adds an additional layer of sophistication and personalization, making the system not just a one-time solution, but a long-term financial planning tool.

In an implementation, the processor 104 is configured to receive input from the user based on the displayed preliminary budgetary recommendation. This allows the user to make adjustments, corrections, or additions to the preliminary budgetary recommendation, thus personalizing it to better suit their specific requirements or circumstances. The user may make these changes through a user interface, perhaps via textual inputs, drop-down selections, or even voice commands which are then processed and interpreted by the system. The user input is crucial as it provides an element of human oversight and individual tailoring to the otherwise automated process.

The method 400 provides the user with an immediate and transparent overview of the final budgetary recommendation, enabling the user to visually confirm that their preferences have been accurately captured. This display could be rendered on various types of displays and/or display units, such as a computer monitor, tablet, or even a smartphone, depending on the system's design and user accessibility preferences.

The visual representation of the final budgetary recommendation serves as a point for any last-minute revisions or approvals. If the user identifies any aspect that requires modification, the user can choose to loop back to earlier steps for further customization, potentially re-engaging with the user interface for changes.

Moreover, the display of the final budgetary recommendation paves the way for its formalization, which could involve digital signing, etc. The display unit may also present options to export the final budgetary recommendation in various formats like portable document format (PDF), or to send it directly to relevant parties via email or other secure channels. Therefore, the step of displaying the final budgetary recommendation serves not just as a culmination of the automated process, but also as a gateway to the final, critical tasks of review and formalization.

For example, the recommendation engine periodically determines whether there is a change in indicators (for example, social indicators, economic indicators, etc.) that could change the budgetary allocation. The recommendation engine may re-run behavioral pattern models to determine whether the user approved final budgetary recommendation requires any changes. If any such changes are identified, the recommendation engine notifies the user via a push mechanism of the optimized budgetary allocation recommendation. The user may then have an option to either review or reject the optimized budgetary allocation recommendation.

In an implementation, the UI provides an option to the user to manually trigger re-verification of the recommendation to manually determine whether any changes are applicable. If any changes are determined, then the user has an option to review the recommendation. The user may then have an option to either review or reject the proposed change.

For example, the at least one processor 104 is configured to periodically determine changes in various economic indicators, historical market data, and the like. This review occurs at predefined time intervals, which can be set according to the user's preference or based on best practices. This ensures that the recommendation and asset recommendation are always in alignment with the most current requirements (for example, social indicators, economic indicators, etc.).

In an example, the target activity corresponds to house purchase planning. In this case, the recommendation engine may require inputs such as current assets of the user, details of the target property the user is planning to purchase, and the like. In addition, the recommendation engine may fetch indicators related to purchase of house in a geographical region. Based on the analysis of the user inputs and the indicators, the recommendation engine may generate the preliminary budgetary recommendation for the user.

For example, the first information for the target activity “house purchase planning” may include information such as country/state/city/town where the property needs to be purchased, timeframe after which the property needs to be purchased, type of property (e.g., single family, apartment, condominium, etc.), age of property, size of property, number of bedrooms/bathrooms/dining areas etc. in the property, furnishing type, number of car parking spaces, and other similar information related to the property.

Further, the second information fetched from the external source may include trends in the real estate market for the country/state/city/town where the property needs to be purchased, current inflation rates in the target real estate market, inflation trends in the target real estate market, cost of ownership trends in the target real estate market, property tax rates in the target real estate market, property tax rate trends in the target real estate market, average trends in application and closing costs, average association membership rates, and similar indicators related to property buying.

The recommendation engine is further configured to analyze the first information and the second information to determine a budgetary allocation recommendation for the selected target activity (e.g., house purchase planning). Furthermore, the processor 104 is configured to generate the preliminary budgetary recommendation based on the determined budgetary allocation. The preliminary budgetary recommendation may include the at least one mini-pot such as a down payment mini-pot, an association feeds mini-pot, an attorney fees mini-pot, a dream house mini-pot, and the like. The preliminary budgetary recommendation is rendered on the display unit of the user device. The user can then add, delete, or modify the at least one mini-pot as per requirement.

Once the user approves the at least one mini-pot and the at least one asset recommendation associated with each mini-pot, the processor 104 is configured to generate the final budgetary recommendation for the target activity (e.g., house purchase planning).

In another example, the target activity corresponds to vehicle purchase planning. In this case, the recommendation engine may require inputs such as current assets of the user, details of the vehicle the user is planning to purchase, and the like. In addition, the recommendation engine may fetch indicators related to purchase of vehicle in a geographical region (e.g., country). Based on the analysis of the user inputs and the indicators, the recommendation engine may generate the preliminary budgetary recommendation for the user.

For example, the first information for the target activity “vehicle purchase planning” may include information such as country/state/city/town of vehicle purchase, tentative timeline of vehicle purchase, manufacturer and make of vehicle, year of vehicle manufacture, preferred color of vehicle, insurance type (e.g., from dealer or third-party vendor), and other similar information related to the vehicle.

Further, the second information fetched from the external source may include price trends for the market for the chosen manufacturer, price trends for the market for other manufacturers than the selected vehicle, current inflation rate in the chosen country and city of vehicle purchase, inflation trends in the chosen country and city of vehicle purchase, current applicable insurance rates for the selected vehicle in the chosen country and city of vehicle purchase, export duties (if any) that may be applicable if the vehicle is being imported from a different country, and similar indicators related to vehicle buying.

The recommendation engine is further configured to analyze the first information and the second information to determine a budgetary allocation recommendation for the selected target activity (e.g., vehicle purchase planning). Furthermore, the processor 104 is configured to generate the preliminary budgetary recommendation based on the determined budgetary allocation. The preliminary budgetary recommendation may include the at least one mini-pot such as a down payment mini-pot, an insurance charges mini-pot, a car mini-pot, and the like. The preliminary budgetary recommendation is rendered on the display unit of the user device. The user can then add, delete, or modify the at least one mini-pot as per requirement.

Once the user approves the at least one mini-pot and the at least one asset recommendation associated with each mini-pot, the processor 104 is configured to generate the final budgetary recommendation for the target activity (e.g., vehicle purchase planning).

In yet another example, the target activity corresponds to wedding planning. In this case, the recommendation engine may require inputs such as catering options, details of the wedding, and the like. In addition, the recommendation engine may fetch indicators related to wedding planning in a geographical region. Based on the analysis of the user inputs and the indicators, the recommendation engine may generate the preliminary budgetary recommendation for the user.

For example, the first information for the target activity “wedding planning” may include information such as country/state/city/town of wedding, tentative timeline of wedding, number of invited guests, preferred catering options for the wedding, specific food and beverage requirements, entertainment options, accommodation options, transportation options, return gifts, and other similar information related to the wedding.

Further, the second information fetched from the external source may include current price estimates for wedding planners in the country and city of planned wedding, price trends for wedding planners in the country and city of planned wedding, inflation trends in the country and city of planned wedding, hotel accommodation price trends in the country and city of planned wedding, transportation price trends in the country and city of planned wedding, current price estimates for catering options based on selected catering preferences, consumer price index for chosen services for the planned wedding, and similar indicators related to wedding planning.

The recommendation engine is further configured to analyze the first information and the second information to determine the budgetary allocation recommendation for the selected target activity (e.g., wedding planning). Furthermore, the processor is configured to generate the preliminary budgetary recommendation based on the determined budgetary allocation. The preliminary budgetary recommendation may include the at least one mini-pot such as a wedding expenses mini-pot, an accommodation mini-pot, a transportation mini-pot, an entertainment mini-pot, a food and beverage mini-pot, and the like. The preliminary budgetary recommendation is rendered on the display unit of the user device. The user can then add, delete, or modify the at least one mini-pot as per requirement.

Once the user approves the at least one mini-pot and the at least one asset recommendation associated with each mini-pot, the processor 104 is configured to generate the final budgetary recommendation for the target activity (e.g., wedding planning).

In yet another example, the target activity corresponds to education planning. In this case, the recommendation engine may require inputs such as university options, accommodation options, and the like. In addition, the recommendation engine may fetch indicators related to education planning in a geographical region. Based on the analysis of the user inputs and the indicators, the recommendation engine may generate the preliminary budgetary recommendation for the user.

For example, the first information for the target activity “education planning” may include information such as name of university, country/city of university, type of course (e.g., under-graduate, graduate, doctorate-level, etc.), timeline of planned education, commute method, accommodation options, available transportation options, food and dietary preferences, whether the hometown of the user is in same country/city as the university, and other similar information related to the education.

Further, the second information fetched from the external source may include current costs for tuition, accommodation, textbooks, and other school supplies at the university, average costs for tuition, accommodation, textbooks, and other school supplies in the preferred country/state/city where the university is located, inflation trends in the selected country, state, and city of planned education, consumer price index in the selected country, state, and city of planned education, consumer price index trends in selected country, state, and city of planned education, purchasing power parity in the selected country, state, and city of planned education, purchasing power parity trends in the selected country, state, and city of planned education, foreign exchange rates between source country and destination country (if the university is in a different country), foreign exchange rate trends between the source country and the destination country (if the university is in a different country), and similar indicators related to education planning.

The recommendation engine is further configured to analyze the first information and the second information to determine the budgetary allocation recommendation for the selected target activity (e.g., education planning). Furthermore, the processor 104 is configured to generate the preliminary budgetary recommendation based on the determined budgetary allocation. The preliminary budgetary recommendation may include the at least one mini-pot such as a tuition expenses mini-pot, an accommodation mini-pot, a school expenses mini-pot, an entertainment mini-pot, a food and beverage mini-pot, a transportation mini-pot, and the like. The preliminary budgetary recommendation is rendered on the display unit of the user device. The user can then add, delete, or modify the at least one mini-pot as per requirement.

Once the user approves the at least one mini-pot and the at least one asset recommendations associated with each mini-pot, the processor 104 is configured to generate the final budgetary recommendation for the target activity (e.g., education planning).

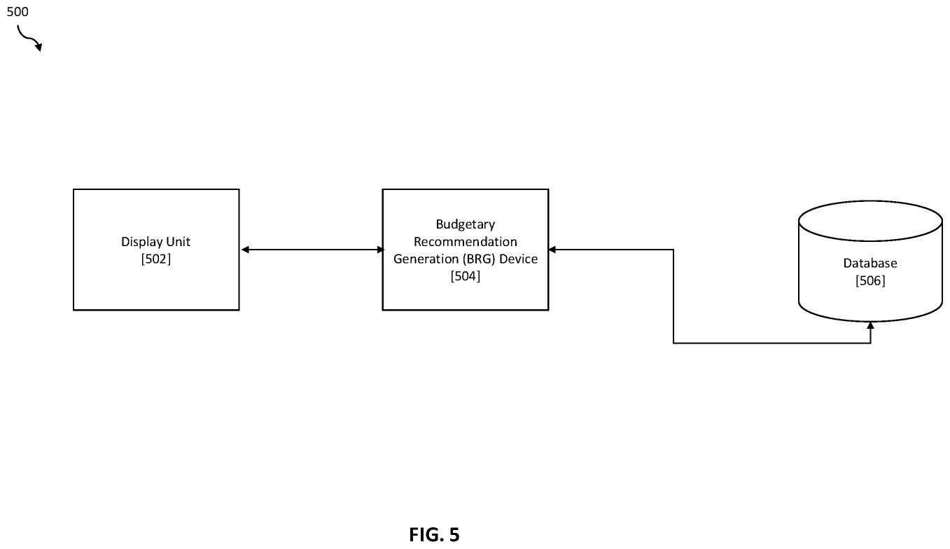

FIG. 5 illustrates a process flow diagram usable for budgetary recommendations, in accordance with an exemplary embodiment. As illustrated in FIG. 5, the process flow 500 begins with receiving, by budgetary recommendation generation (BRG) device 504, the first information associated with the set of preferences that corresponds to the selected target activity. The BRG device 504 gathers essential information about a user's preferences, which can include but are not limited to, travel preferences, shopping preferences, accommodation preferences and the like. This data collection can happen through a secure web interface or application where the user inputs relevant details.

The BRG device 504 fetches additional data from external sources, including, for example, government databases or trusted news outlets, to gauge the economic stability and market conditions. The BRG device 504 fetches real-time economic indicators like inflation rates, consumer price index trends, and others to form a complete picture of the economic landscape. Further, the recommendation engine uses machine learning techniques, to perform a multi-variable analysis on both the first information and the second information. The goal is to determine the budgetary allocation recommendation.

Based on the budgetary allocation recommendation, a preliminary budgetary recommendation is automatically generated by the processor 104. The preliminary budgetary recommendation outlines how funds would be distributed among the assets and under what conditions. The preliminary budgetary recommendation is then displayed on a user interface. The user can review it and provide feedback. Taking into account the user inputs, the BRG device 504 refines the draft to produce a final version (e.g., final budgetary recommendation). The final budgetary recommendation is then displayed on the display unit 502 to receive the user input for final approval or further revisions. The BRG device 504 keeps on monitoring for a change in relevant economic data to suggest timely modifications in the final budgetary recommendation. These updates are notified to the user as recommendations, and alerts can be generated to prompt user action. Further, any user feedback received through the system is used to update the recommendation engine. This makes the system adaptive and improves its decision-making capabilities over time. The BRG device 504 may extract data from various external resources, which may include database 506, that track economic indicators, market trends, and even geopolitical events that could affect asset values. It will be appreciated by the person skilled in the art that the BRG device 504 offers a full-circle, adaptable, and intelligent solution for automating the highly complex task of asset allocation and recommendation drafting.

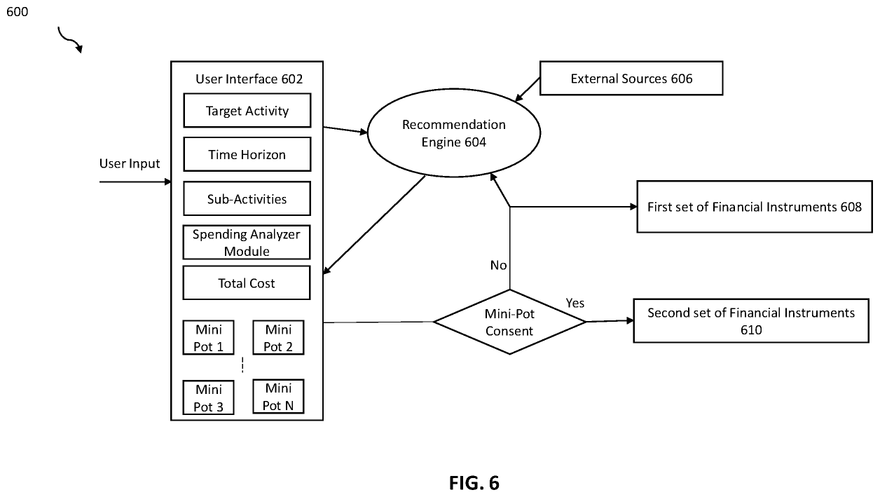

FIG. 6 illustrates an exemplary system flow diagram of a recommendation engine for generating recommendations, in accordance with an embodiment of the present disclosure. As illustrated in FIG. 6, the system flow 600 begins with receiving a user input via a user interface (UI) 602. The UI 602 is adept at capturing a variety of user inputs. Specifically, UI 602 may process inputs such as the ‘target activity’, which denotes the precise financial endeavor the user aims to undertake, and the ‘time horizon’, indicating the span over which the user envisages their investments or expects outcomes. Furthermore, the UI 602 accommodates ‘sub-activities’ that are incremental tasks associated with the primary activity, and an integrated ‘spending analyzer module’ which serves to scrutinize the user's expenditure behavior. Users also have the liberty to glean or input data concerning the ‘total cost’ affiliated with their target activity. A novel feature of the UI 602 is the inclusion of ‘mini-pots’, modular segments that facilitate the compartmentalization of finances, promoting a structured approach to fiscal planning.

After user input, recommendation engine 604 fetches springs into action. Its pivotal role is to amalgamate user-provided data with insights from diverse sources to yield refined recommendations. To enhance the pertinence and precision of its suggestions, the recommendation engine 604 fetches data from external sources 606. These encompass a spectrum from authoritative government databases to credible news platforms. The primary motivation here is to extract a nuanced understanding of the prevailing economic milieu. Variables such as inflation trajectories and consumer price index trends become instrumental in this endeavor. The engine does not stop at mere data collection; it delves deeper by applying sophisticated machine learning methodologies. Through a rigorous multi-variable analysis that juxtaposes user input with real-time economic parameters, the engine formulates an accurate projection of the total costs linked to the target activity. Concurrently, it also identifies suitable mini-pots to streamline financial planning.

Once the analytical phase culminates, users are granted the autonomy to engage with the generated at least mini-pot. Their interaction is multifaceted; they can outright ‘Reject’ the first batch of at least one mini-pot that may seem discordant with their preferences or ‘Amend’ the secondary set to tweak them as per evolving needs. Additionally, they have the latitude to ‘Add’ a tertiary set, further accentuating the system's adaptability.

Rounding off the process, based on the user's refined inputs concerning the at least one mini-pot, the system presents a curated selection of financial instruments. These are bifurcated into two distinct sets: the ‘first set of financial instruments 608’, which might comprise conservative or strategy-aligned tools, and the ‘second set of financial instruments 610’, which offers a contrasting or potentially more aggressive financial trajectory.

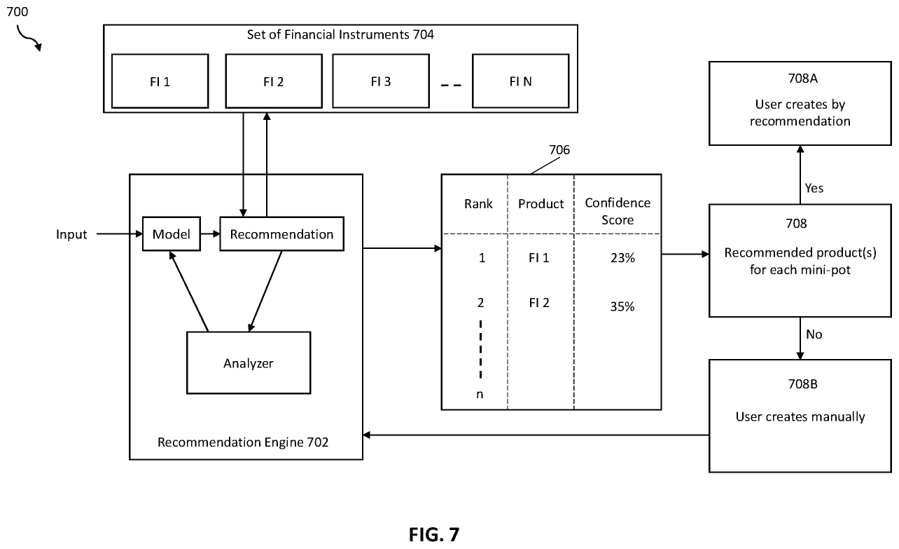

FIG. 7 illustrates an exemplary system flow diagram for ranking asset recommendations based on confidence score, in accordance with an embodiment of the present disclosure. As illustrated, the system flow 700 for ranking recommendations initiates by reception of input by a recommendation engine 702.

The recommendation engine 702 is configured to generate budgetary allocations as well as formulating at least one mini-pot, serving as financial partitions or categories. The recommendation engine 702 is modular and consists of three primary components.

Firstly, a model is structured to receive and process diverse inputs. These inputs can span a range of parameters, potentially including user preferences, historical financial data, and more.

Secondly, recommendation bridges the gap between the trained model and a set of financial instruments 704. It is architected to both send and receive inputs to and from these instruments, enabling a dynamic two-way communication channel.

Thereafter, analyzer analyzes the input and information fetched from external sources to determine a budgetary allocation recommendation for the selected target activity to be completed within the first predefined time period. In one exemplary implementation, the recommendation engine may implement or run a trained model. In some examples, the trained model may include one from among a machine learning algorithm, artificial intelligence algorithm, neural network model (e.g., convolution neural network (CNN), recurrent neural network (RNN), etc.), and the like.

The recommendation engine 702 fetches a set of financial instruments 704, such as FI1, FI2, FI3, . . . , FIN. Each instrument within financial instruments 704 represents a unique financial product, tool, or strategy that can be recommended based on user inputs and other relevant parameters.

The recommendation engine 702 further embarks on the task of ranking the recommendations 706 related to a financial product from the set of financial instruments 704. This ranking mechanism is not arbitrary but deeply rooted in the confidence score's analytics. The higher a confidence score, the more aligned, relevant, and probable a recommendation is perceived to be in resonating with user needs and conditions.

Upon finalizing the rankings, for each of the at least one mini-pot, a corresponding financial instrument (or product) is recommended. However, the system ensures user autonomy by presenting them with an opportunity to engage with these recommendations using component 708. The user, after scrutinizing the proposed at last one mini-pot may accept or reject the proposed recommendation for the at least one mini-pot.

If the user finds resonance with the proposed recommendations, they proceed with the “user creates by recommendation 708A” pathway. This implies that the user is aligning with the system's suggestions, leading to a more streamlined financial planning experience.

Should there be any discrepancies or misalignments with the user's objectives, the system allows the user to deviate from the proposed path. Opting for the “user creates manually 706B” route, the user can manually tailor or adjust the at least one mini-pot, ensuring a bespoke financial planning process.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for generating a budgetary recommendation is disclosed. The instructions include executable code which, when executed by a processor, may cause the processor to enable a user to select a target activity from a predetermined plurality of activities, wherein the target activity is to be completed within a first predefined time period; receive first information associated with a set of preferences that corresponds to the selected target activity; retrieve second information associated with the selected target activity and the first information, wherein the second information is retrieved from at least one external source; analyze, using a recommendation engine, the first information and the second information to determine a budgetary allocation for the selected target activity; generate a preliminary budgetary recommendation based on the determined budgetary allocation; render, via a display, the preliminary budgetary recommendation to receive a user input; and generate a final budgetary recommendation based on the user input received on the preliminary budgetary recommendation.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing detailed description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the detailed description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating a budgetary recommendation, the method being implemented by at least one processor, the method comprising:
enabling, by the at least one processor, a user to select a target activity from a predetermined plurality of activities, wherein the target activity is to be completed within a first predefined time period;
receiving, by the at least one processor, first information associated with a set of preferences that corresponds to the selected target activity;
retrieving, by the at least one processor, second information associated with the selected target activity and the first information, wherein the second information is retrieved from at least one external source;
analyzing, by the at least one processor using a recommendation engine, the first information and the second information to determine a budgetary allocation for the selected target activity;
generating, by the at least one processor, a preliminary budgetary recommendation based on the determined budgetary allocation;
rendering, by the at least one processor via a display, the preliminary budgetary recommendation to receive a user input; and
generating, by the at least one processor, a final budgetary recommendation based on the user input received in response to the preliminary budgetary recommendation.

2. The method as claimed in claim 1, wherein the method further comprises:
analyzing, by the at least one processor, the user input to identify a user behavioral pattern towards the rendered preliminary budgetary recommendation; and
predicting, by the at least one processor using the recommendation engine, an optimal amount for the final budgetary recommendation based on a result of the analyzing of the user behavioral pattern.

3. The method as claimed in claim 1, wherein the predetermined plurality of activities comprises retirement planning, house purchase planning, vacation planning, vehicle purchase planning, wedding planning, education planning, and at least one other type of financial planning.

4. The method as claimed in claim 1, wherein the first information comprises at least one from among a time horizon, a destination preference, a transportation preference, a dining preference, a shopping preference, an accommodation preference, an itinerary preference and any other target activity related preference, and wherein the second information comprises economic indicator data that comprises at least one from among price trends, inflation trends, current news, current affairs, market trends, purchasing power parity trends, foreign exchange rate trends, and any other economic indicators associated with the selected target activity.

5. The method as claimed in claim 1, wherein the method further comprises:
periodically determining, by the at least one processor, a change in the second information upon completion of a second predefined time period;
optimizing, by the at least one processor, the final budgetary recommendation to enable completion of the selected target activity within the first predefined time period based on the change in the second information, wherein the first predefined time period is one from among a user-defined time period and a time period that is defined by the recommendation engine; and
transmitting, by the at least one processor, a notification to alert the user about the optimized final budgetary recommendation.

6. The method as claimed in claim 1, further comprising recommending, by the at least one processor, at least one mini-pot to achieve a budgetary amount, corresponding to the final budgetary recommendation, within the first predefined time period.

7. The method as claimed in claim 6, further comprising receiving, by the at least one processor, a modification input from the user to perform at least one from among an addition, a deletion, and a modification in the recommended at least one mini-pot.

8. The method as claimed in claim 6, further comprising one from among:
automatically recommending, by the at least one processor, an allocation of at least one asset for the recommended at least one mini-pot; and
receiving, by the at least one processor, the user input to manually allocate the at least one asset to each of the recommended at least one mini-pot.

9. The method as claimed in claim 8, wherein the method further comprises:
determining, by the at least one processor, a confidence score corresponding to the allocated at least one asset, wherein the confidence score represents a probability of the allocation of the at least one asset to achieve the selected target activity within the first predefined time period.

10. A computing device configured to implement an execution of a method for generating a budgetary recommendation, the computing device comprising:
a processor;
a memory; and
a communication interface coupled to each of the processor and the memory, wherein the processor is configured to:
enable a user to select a target activity from a predetermined plurality of activities, wherein the target activity is to be completed within a first predefined time period;
receive first information associated with a set of preferences that corresponds to the selected target activity;
retrieve second information associated with the selected target activity and the first information, wherein the second information is retrieved from at least one external source;
analyze, using a recommendation engine, the first information and the second information to determine a budgetary allocation for the selected target activity;
generate a preliminary budgetary recommendation based on the determined budgetary allocation;
render, via a display, the preliminary budgetary recommendation to receive a user input; and
generate a final budgetary recommendation based on the user input received in response to the preliminary budgetary recommendation.

11. The computing device as claimed in claim 10, wherein the processor is further configured to:
analyze the user input to identify a user behavioral pattern towards the rendered preliminary budgetary recommendation; and
predict, using the recommendation engine, an optimal amount for the final budgetary recommendation based on the analysis of the user behavioral pattern.

12. The computing device as claimed in claim 10, wherein the predetermined plurality of activities comprises retirement planning, house purchase planning, vacation planning, vehicle purchase planning, wedding planning, education planning, and at least one other type of financial planning.

13. The computing device as claimed in claim 10, wherein the first information comprises at least one from among a time horizon, a destination preference, a transportation preference, a dining preference, a shopping preference, an accommodation preference, an itinerary preference and any other target activity related preference, and wherein the second information comprises economic indicator data that comprises at least one from among price trends, inflation trends, current news, current affairs, market trends, purchasing power parity trends, foreign exchange rate trends, and any other economic indicators associated with the selected target activity.

14. The computing device as claimed in claim 10, wherein the processor is further configured to:
periodically determine a change in the second information upon completion of a second predefined time period;
optimize the final budgetary recommendation to enable completion of the selected target activity within the first predefined time period based on the change in the second information, wherein the first predefined time period is one from among a user-defined time period and a time period that is defined by the recommendation engine; and
transmit a notification to alert the user about the optimized final budgetary recommendation.

15. The computing device as claimed in claim 10, wherein the processor is further configured to recommend at least one mini-pot to achieve a budgetary amount, corresponding to the final budgetary recommendation, within the first predefined time period.

16. The computing device as claimed in claim 15, wherein the processor is further configured to receive a modification input from the user to perform at least one from among an addition, a deletion, and a modification in the recommended at least one mini-pot.

17. The computing device as claimed in claim 15, wherein the processor is further configured to perform one from among:
automatically recommending an allocation of at least one asset for the recommended at least one mini-pot; and
receiving the user input to manually allocate the at least one asset to each of the recommended at least one mini-pot.

18. The computing device as claimed in claim 17, wherein the processor is further configured to determine a confidence score corresponding to the allocated at least one asset, wherein the confidence score represents a probability of the allocation of the at least one asset to achieve the selected target activity within the first predefined time period.

19. A non-transitory computer-readable storage medium storing instructions for generating a budgetary recommendation, the instructions including executable code which, when executed by a processor, causes the processor to:
enable a user to select a target activity from a predetermined plurality of activities, wherein the target activity is to be completed within a first predefined time period;
receive first information associated with a set of preferences that corresponds to the selected target activity;
retrieve second information associated with the selected target activity and the first information, wherein the second information is retrieved from at least one external source;
analyze, using a recommendation engine, the first information and the second information to determine a budgetary allocation for the selected target activity;
generate a preliminary budgetary recommendation based on the determined budgetary allocation;
render, via a display, the preliminary budgetary recommendation to receive a user input; and
generate a final budgetary recommendation based on the user input received in response to the preliminary budgetary recommendation.

20. The storage medium as claimed in claim 19, wherein when executed by the processor, the executable code further causes the processor to:
analyze the user input to identify a user behavioral pattern towards the rendered preliminary budgetary recommendation; and
predict, using the recommendation engine, an optimal amount for the final budgetary recommendation based on the analysis of the user behavioral pattern.
